(19) United States
(12) Patent Application Publication
(10) Pub. No.: US 2024/0411516 A1
(43) Pub. Date: Dec. 12, 2024

(54) METHOD AND DEVICE FOR PRECISION ALLOCATION BASED ON NEURAL NETWORK PROCESSOR

(71) Applicant: SAMSUNG ELECTRONICS CO., LTD., SUWON-SI (KR)

(72) Inventors: Penghui WEI, Xi’an (CN); Gang SUN, Xi’an (CN); Jiao WU, Xi’an (CN); Hyeonuk SIM, Suwon-si (KR)

(21) Appl. No.: 18/734,138

(22) Filed: Jun. 5, 2024

(30) Foreign Application Priority Data
Jun. 8, 2023 (CN) 202310679960.4
Mar. 29, 2024 (KR) 10-2024-0043554

(51) Int. Cl. G06F 7/523

(52) U.S. Cl. CPC G06F 7/523

(57) ABSTRACT

A precision allocation method and device based on a neural network processor are provided. The precision allocation method includes allocating a weight of a neural network to a multiplier column of a neural network processor, determining a lower tolerance for the multiplier column, and selecting a first data type for the multiplier column from a plurality of data types based on the lower tolerance, wherein each of the plurality of data types corresponds to a different precision level, and performing, by the neural network processor, a multiplication operation based on the weight and the first data type.

### CROSS-REFERENCE TO RELATED APPLICATION

This application is based on and claims priority under 35 U.S.C. § 119 to Chinese Patent Application No. 202310679960.4, filed on Jun. 8, 2023, in the China National Intellectual Property Administration, and Korean Patent Application No. 10-2024-0043554, filed on Mar. 29, 2024, in the Korean Intellectual Property Office, the contents of which are incorporated by reference herein in their entirety.

### BACKGROUND

### 1. Field of the Invention

One or more embodiments relate to the field of neural network model acceleration and performance optimization, and particularly, to a precision allocation method and device based on a neural network processor.

### 2. Description of the Related Art

In recent years, the proliferation of neural network processors (NNPs) has revolutionized the field of artificial intelligence and machine learning, enabling the development of advanced models with unprecedented capabilities. The specialized processors are optimized for performing the complex computations required by neural networks, facilitating tasks such as image recognition, natural language processing, and autonomous decision-making. However, efficient allocation of computational resources within NNP-based systems remains a critical challenge, particularly in scenarios where precision requirements vary across different layers or components of the neural network architecture.

The present disclosure addresses the challenge by introducing a method and device for precision allocation based on neural network processors. Conventional methods to resource allocation often rely on fixed precision settings for the computations within the neural network, leading to suboptimal utilization of computational resources and potential accuracy loss in certain tasks. Therefore, there is a need in the art for a precision allocation algorithm that may meet the said requirements.

### SUMMARY

Embodiments of the present disclosure provide a precision allocation method and device based on a neural network processor. In some cases, a weight of a neural network may be allocated to multiplier columns of the neural network processor. According to an embodiment, a lower tolerance for each of the multiplier columns may be determined based on a preset total tolerance. Additionally, a first data type of each of the multiplier columns from a plurality of data types with different accuracies may be determined based on the lower tolerance. The neural network processor may perform an operation of the neural network based on the weight and the first data type.

According to an aspect, there is provided a precision allocation method based on a neural network processor, the precision allocation method including allocating a weight of a neural network to a multiplier column of a neural network processor, determining a lower tolerance for the multiplier column, and selecting a first data type for the multiplier column from a plurality of data types based on the lower tolerance, wherein each of the each of the plurality of data types corresponds to a different precision level, and performing, by the neural network processor, a multiplication operation based on the weight and the first data type.

The lower tolerance is based on a preset total tolerance may representing an upper limit of an allowable error for performing precision allocation.

The determining of the lower tolerance for the multiplier column may include determining a proportionality coefficient for the multiplier column based on a weight of the multiplier column, and determining the lower tolerance based on the preset total tolerance and the proportionality coefficient.

The determining of the proportionality coefficient for the multiplier column may include determining a variance of the multiplier column and normalizing the variance.

The method further comprises allocating weights of the neural network to a plurality of multiplier columns of the neural network processor, wherein a size of each of the plurality of multiplier columns is 1×1×M, where M may be a positive integer.

The selecting of the first data type may include determining that the first data type results in a data type error that is lower than the lower tolerance.

The method may further include selecting of the first data type comprising selecting a preliminary data type for the multiplier column from the plurality of data types, wherein the preliminary data type has a lower precision level than the first data type, determining that the preliminary data type does not meet a tolerance condition based on the lower tolerance, and selecting the first data type based on the determination that the preliminary data type does not meet the tolerance condition.

The plurality of data types may include a dynamic floating point small (DFP_S) data type, a dynamic floating point medium (DFP_M) data type, and a dynamic floating point large (DFP_L) data type.

According to another aspect, there is provided a computing device including a multiple-column allocator configured to allocate a weight of a neural network to a multiplier column of a neural network processor, a lower tolerance determiner configured to determine a lower tolerance for the multiplier column, and a data type determiner configured to select a first data type for the multiplier column from a plurality of data types based on the lower tolerance, wherein each of the plurality of data types corresponds to a different precision level.

The lower tolerance is based on a preset total tolerance that may represent an upper limit of an allowable error for performing precision allocation.

The lower tolerance determiner may be configured to determine a proportionality coefficient for the multiplier column based on a weight of the multiplier column and determine the lower tolerance based on the preset total tolerance and the proportionality coefficient.

The lower tolerance determiner may be configured to determine a variance of the multiplier column and normalize the variance.

The computing device, wherein the multiple-column allocator is further configured to allocate weights of the neural network to a plurality of multiplier columns of the neural network processor, wherein a size of each of the plurality of multiplier columns may be 1×1×M, wherein M may be a positive integer.

The data type determiner may be configured to select the first data type further comprising determine that the first data type results in a data type error that is lower than the lower tolerance.

The computing device may further include a fine adjuster configured to select a preliminary data type for the multiplier column from the plurality of data types, wherein the preliminary data type has a lower precision level than the first data type, determine that the preliminary data type does not meet a tolerance condition based on the lower tolerance, and select the first data type based on the determination that the preliminary data type does not meet the tolerance condition.

The plurality of data types may include a DFP_S data type, a DFP_M data type, and a DFP_L data type.

According to another aspect, there is provided an electronic device including a memory and a processor, wherein the processor is configured to allocate a weight of a neural network to a multiplier column of a neural network processor, determine a lower tolerance for the multiplier column, and select a first data type for the multiplier column from a plurality of data types based on the lower tolerance, wherein each of the plurality of data types corresponds to a different precision level, and perform a multiplication operation based on the weight and the first data type.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings:

FIG. 1 is a diagram illustrating a neural processing unit (NPU) operation and multiplier columns according to an embodiment;

FIG. 2 is a flowchart illustrating an NPU-based precision allocation method according to an embodiment;

FIG. 3 is a diagram illustrating determination of a first data type having a degree of precision corresponding to each of multiplier columns according to an embodiment;

FIG. 4 is a block diagram illustrating a precision allocation device based on an NPU according to an embodiment; and

FIG. 5 is a block diagram illustrating an electronic device for performing precision allocation based on an NPU according to an embodiment.

### DETAILED DESCRIPTION

Embodiments of the present disclosure provide a precision allocation method and device based on a neural network processor. In some cases, a weight of a neural network may be allocated to multiplier columns of the neural network processor. According to an embodiment, a lower tolerance for each of the multiplier columns may be determined based on a preset total tolerance. Additionally, a first data type of each of the multiplier columns from a plurality of data types with different accuracies may be determined based on the lower tolerance. The neural network processor may perform an operation of the neural network based on the weight and the first data type.

However, conventional mixed-precision algorithms may not adapt to a computing mode of a neural network processor (a neural processing unit (NPU)). Additionally, such mixed-precision algorithms require a large amount of training and learning processes resulting in consumption of a high amount of computing resources and time. Further, conventional mixed-precision algorithms may not be able to achieve comprehensive and balanced improvements in terms of mixed-precision granularity. As a result, training requirements of the neural network processor may not be met and the algorithm efficiency and effectiveness may not improve significantly.

By contrast, embodiments of the present disclosure include a neural network model acceleration and performance optimization system that includes a precision allocation method based on a neural network processor. According to an embodiment, a neural processing unit (NPU) may include multiplier columns that may be determined with granularity of mixed-precision based on the computational characteristics of the NPU. In some cases, a weight of a neural network may be allocated to multiplier columns and a lower tolerance may be determined for each of the multiplier columns based on a preset total tolerance.

According to an embodiment, the preset total tolerance may represent the upper limit of the allowable error for the weight elements of the precision allocation and the lower tolerance may represent the upper limit of the allowable error for each of the multiplier columns. In some cases, the lower tolerance may be determined using a proportionality coefficient of each of the multiplier columns that may be based on a weight of each of the multiplier columns. A data type (such as a dynamic floating point (DFP) data type or a DFP data type with different degrees of precision) of each of the multiplier columns with different accuracies may be determined based on the lower tolerance.

According to an exemplary embodiment, a data type error may be obtained using a high-precision data type (e.g., FP16) and a current data type (e.g., DFP data type). In some cases, the data type error may be compared with the lower tolerance of the current multiplier columns and may be sequentially accumulated in ascending order to obtain a global precision error. As such, priority may be given to using low-precision data types which prevents loss of precision and reduces computational complexity.

Accordingly, a mixed-precision algorithm may be effective for neural network model acceleration and performance optimization. The mixed-precision algorithm may allocate and set various data types and/or data precisions for different parts of a neural network model. Compared to use a high-precision data type (e.g., floating point (FP) 32, FP16, etc.) for an entire model, the mixed-precision algorithms may reduce computational complexity and storage consumption of a neural network model while maintaining low precision error loss.

Embodiments of the present disclosure include a mixed precision allocation method based on a neural network processor. In some cases, the allocation method comprises allocating a weight of a neural network to a multiplier column of a neural network processor. A lower tolerance for the multiplier column may be determined before selecting a first data type for the multiplier column from a plurality of data types. In some cases, each of the plurality of data types corresponds to a different precision level. The neural network processor performs a multiplication operation based on the weight and the first data type.

Accordingly, by dynamically adjusting precision levels based on the specific requirements of each layer or operation within the neural network, the present method and device optimize resource utilization while preserving accuracy and performance. The precision-aware allocation scheme leverages the capabilities of NNPs to handle varying precision requirements efficiently, enhancing the overall efficiency and effectiveness of neural network-based systems across a wide range of applications.

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

The same name may be used to describe an element included in the embodiments described above and an element having a common function. Unless otherwise mentioned, the descriptions on the embodiments may be applicable to the following embodiments and thus, duplicated descriptions will be omitted for conciseness.

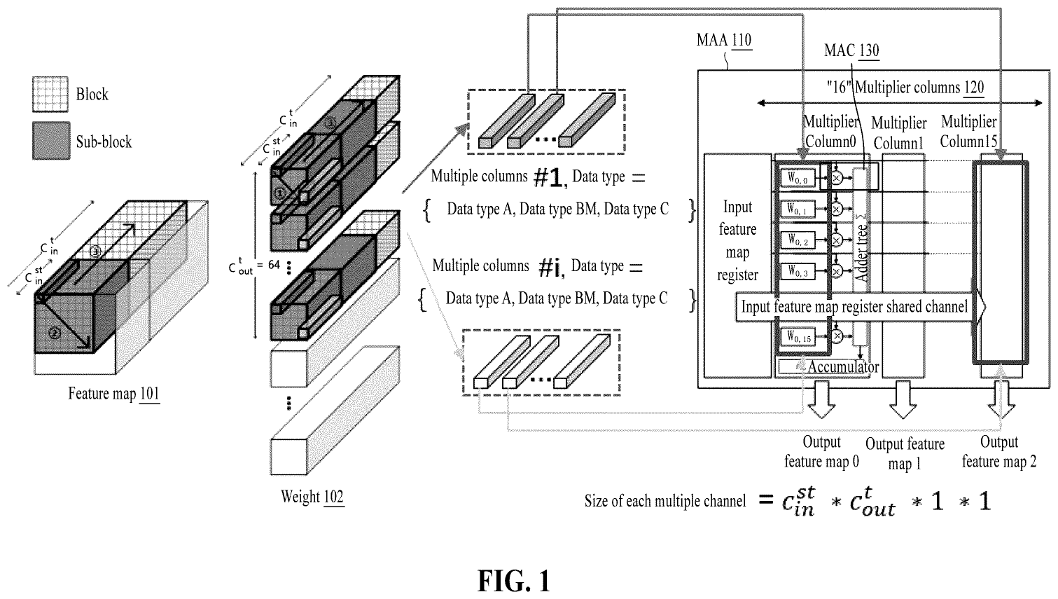

FIG. 1 is a diagram illustrating a neural processing unit (NPU) operation and multiplier columns, according to an embodiment.

A neural processing unit (NPU) is a microprocessor that specializes in the acceleration of machine learning algorithms. For example, an NPU may operate on predictive models such as artificial neural networks (ANNs) or random forests (RFs). In some cases, an NPU is designed in a way that makes it unsuitable for general purpose computing such as that performed by a Central Processing Unit (CPU). Additionally or alternatively, the software support for an NPU may not be developed for general purpose computing.

An artificial neural network (ANN) is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

As shown in FIG. 1, NPU may include a preset number of multiply and accumulate arrays (MAAs) 110 and each of the MAAs 110 may include a preset number of multiplier columns 120. Each of the multiplier columns 120 may include a preset number of multiply and accumulate (MAC) units 130.

Referring to the example shown in FIG. 1, the NPU includes four MAAs 110 (e.g., a single MAA 110 is depicted as an example in FIG. 1), each of the MAAs 110 may include “16” multiplier columns 120, and each of the multiplier columns 120 includes “16” MAC units 130. However, it should be understood that embodiments are not limited thereto. A convolution operation process of the NPU may be divided into a plurality of main operation steps, as described herein.

As a first step, e.g., cₒᵤₜ^{t} may be set to 64, i.e., “cₒᵤₜ^{t}=64”. As used herein, cₒᵤₜ^{t} refers to the product of the number of MAAs 110 and the number of multiplier columns 120). In some cases, cᵢₙ^{st} may be set as 1×1×16. As used herein, cᵢₙ^{st} represents the height and width of a weight and the number of rows of the multiplier columns. For example, the value of 1×1 represents the height and the width of a weight, respectively, and 16 corresponds to the number of rows of the multiplier columns 120. In some cases, cᵢₙ^{st} weight element may be loaded into the MAA 110. Accordingly, 64 pillar elements of 1×1×16, which are loaded each time, may be referred to as multi-pillars. In some cases, the weight which is a tensor, may include multiple elements, and may be divided into “64” pillar elements of 1×1×16.

As a second step, element blocks in an input feature map may be divided. For example, element blocks in cᵢₙ^{st} that may be set as 1×1×16 (where, 1×1 corresponds to the height and the width of the weight, respectively, and 16 corresponds to the number of rows of the multiplier columns 120) may be divided. In some cases, the element blocks may be loaded into an input feature map register of the NPU. Additionally, input feature map data of a corresponding register may be shared by a multiplier of the columns of the MAAs 110.

Finally, a vector dot product may be computed between the input feature map of 1×1×16 and the weight of 64×1×1×16. In some cases, a partial sum result is generated as an output of the computation.

Accordingly, multiplier columns may represent the amount of weight data loaded by the NPU in an operation and the size of the multiplier columns may be “N” weight elements of 1×1×M. Here, N and M are positive integers and represent a division size of the weight according to an output channel and an input channel, respectively. As described, 1×1 represents the height and the width of the weight, respectively.

As used herein, the division size of the weight in the neural network may refer to the granularity or precision with which the weights may be represented. In some cases, the division size of the weight is determined by the data type used to store the weights. For example, weights of a neural network may be represented using floating-point numbers and the division size may refer to the smallest distinguishable increment that can be represented by the chosen data type.

Therefore, the multiplier columns may be determined with granularity of mixed-precision based on the computational characteristics of the NPU. For example, the multiplier columns may be loaded into “64×1×1×16” (one multi-column) weight elements of the MAAs 110 to maintain the same data precision and/or data type. In some cases, granularity of mixed-precision that the NPU hardware recognizes, may be achieved since data types of different multiplier columns may be different. In some cases, the granularity of such mixed-precision may not be limited to a specific NPU and the multiplier columns may be determined by the amount of weight data loaded by the NPU for an operation based on the NPU currently being used.

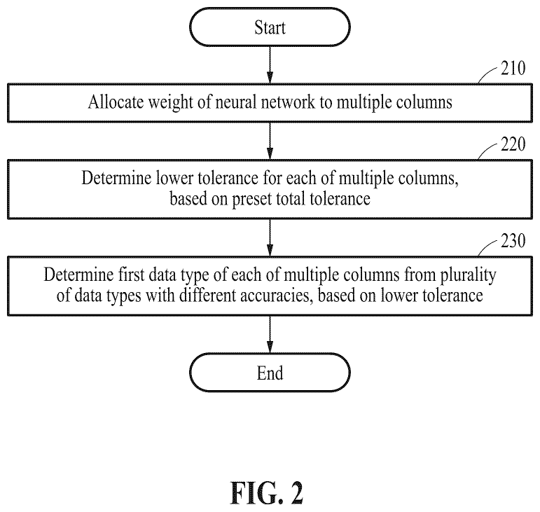

FIG. 2 is a flowchart illustrating an NPU-based precision allocation method according to an embodiment.

Referring to FIG. 2, in operation 210, a weight of a neural network may be allocated to multiplier columns according to the precision allocation method described in the present disclosure. In some cases, each of the multiplier columns may be the amount of weight data loaded by the NPU for an operation. In some cases, the size of the multiplier columns may be “N” weight elements of 1×1×M. As used herein, N and M are positive integers and represent the division size of the weight according to an output channel and an input channel, respectively.

As described, 1×1 represents the height and the width of the weight, respectively. Additionally, the multiplier columns described herein may be the same as described with reference to FIG. 1 and therefore repeated descriptions are omitted herein for brevity. Furthermore, the weight may be a tensor including a plurality of weight elements and may be of a high-precision data type (e.g., floating point (FP) 16).

According to the precision allocation method of the present disclosure, in operation 220, a lower tolerance may be determined for each of the multiplier columns based on a preset total tolerance. In some cases, the preset total tolerance may represent the upper limit of an allowable error for precision allocation. In some cases, the preset total tolerance may represent the upper limit of the allowable error for the weight elements of the precision allocation. Additionally, the lower tolerance may represent the upper limit of the allowable error for each of the multiplier columns (including partial weight elements) of the precision allocation.

Additionally, according to the precision allocation method of the present disclosure, in operation 220, a proportionality coefficient of each of the multiplier columns may be determined based on a weight of each of the multiplier columns and the lower tolerance for each of the multiplier columns may be determined based on the preset total tolerance and the proportionality coefficient of each of the multiplier columns.

In some cases, the lower tolerance of each of the multiplier columns may be obtained by multiplying the preset total tolerance by the proportionality coefficient of each of the multiplier columns. As an example, according to the precision allocation method of the present disclosure, when a proportionality coefficient for each of the multiplier columns is determined, a variance of each of the multiplier columns may be determined based on the weight of each of the multiplier columns and the variance of each of the multiplier columns may be normalized with the proportionality coefficient.

In some cases, the preset total tolerance may be obtained by a maximum weight error (MWE) parameter preset by a user. The MWE parameter may represent the upper limit of the allowable error of each weight element of precision allocation. The MWE in the context of a neural network may refer to the largest allowable discrepancy between the actual output of the network and the desired output during training, considering the weights as the variables being adjusted. In some cases, the MWE may set a limit on how much the weights can be adjusted in each iteration of the training process. Additionally, the preset total tolerance may be obtained by multiplying the MWE parameter by the number of weight elements.

According to the precision allocation method of the present disclosure, in operation 230, a first data type of each of the multiplier columns from a plurality of data types with different accuracies may be determined based on the lower tolerance. As an example, the plurality of data types may use dynamic floating point (DFP) data types. In some examples, the plurality of data types may include three levels of DFP data types of different degrees of precision, that is, a dynamic floating point small (DFP_S) data type, a dynamic floating point medium (DFP_M) data type, and a dynamic floating point large (DFP_L) data type.

Additionally, in operation 230, a data type of the lowest degree of precision may be obtained from the plurality of data types. In some cases, the data type of the lowest degree of precision may refer to a data type in which a data type error for each of the multiplier columns is less than the lower tolerance. In some cases, the data type of the lowest degree of precision (e.g., in which the data type error is smaller than the lower tolerance) may be determined as the first data type. In some cases, the data type error may be an error occurring due to the precision of the data type.

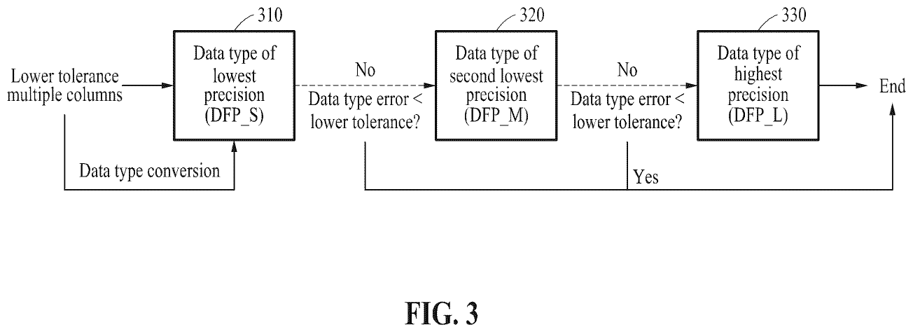

Hereinafter, operation 230 is described in more detail with reference to FIG. 3.

FIG. 3 illustrates determination of a first data type having a degree of precision corresponding to each of multiplier columns, according to an embodiment.

Referring to FIG. 3, according to the precision allocation method of the present disclosure, the data type of the lowest degree of precision (e.g., a DFP_S data type 310) from the DFP data types may be selected first in the case of the current multiplier columns. In some cases, the data type error caused by the corresponding data type may be calculated. In some examples, the data type error may be obtained using an original high-precision data type (e.g., FP16) and a current data type (e.g., the DFP_S data type 310).

Subsequently, the obtained data type error may be compared with the lower tolerance of the current multiplier columns. That is, the selection of the first data type comprises selecting a preliminary data type for the multiplier column from the plurality of data types, wherein the preliminary data type has a lower precision level than the first data type. In some cases, the preliminary data type does not meet a tolerance condition based on the lower tolerance.

Referring again to FIG. 3, in some cases, when the data type error is smaller (i.e., lower or less) than the lower tolerance, the data type currently selected (e.g., the DFP_S data type 310) may be used as the first data type of the current multiplier columns. In some cases, when the data type error is greater (i.e., higher or more) than the lower tolerance, the data type may be replaced by a data type of higher-level precision (e.g., a DFP_M data type 320). As such, the first data type may be selected based on the determination that the preliminary data type does not meet the tolerance condition.

According to an embodiment, the calculation of the data type error may be performed again (e.g., repeatedly) until a data type error that is smaller than (or less than) the lower tolerance is selected. Thus, when the data type error of the data type currently selected (e.g., the DFP_M data type 320) is greater than (or more than) the lower tolerance, the data type may be replaced by a data type of higher-level precision (e.g., a DFP_L data type 330).

In some cases, (e.g., operation 230 described with reference to FIG. 2), a priority may be given to using low-precision data types which prevents significant loss of precision and reduces computational complexity by increasing the ratio of low-precision data types.

Referring again to FIG. 2, according to the precision allocation method of the present disclosure, a set of operations may be performed to convert the multiplier columns, in which the high-precision data types are allocated in operation 230, into a data type of precision as low as possible, in order to further fine-tune (e.g., finely adjust) the data type.

According to a first step of the set of operations, a data type may be obtained for each of the multiplier columns. In some cases, the obtained data type may refer to a data type in which a degree of precision is one level lower than the first data type among the plurality of data types.

According to a second step, the data types obtained according to data type errors may be sorted in ascending order. For example, the data type errors may similarly be obtained, i.e., based on the first data type and the low-level data type currently obtained, as described with reference to FIG. 3.

According to a third step, the data type errors of the obtained data types may be sequentially accumulated to a global precision error in ascending order. In some cases, the obtained data type may be sequentially accumulated until the accumulated global precision error is greater than or equal to the preset total tolerance. That is, the operation may start with the data type of the smallest data type error and increase to a data type with the largest data type error (i.e., till the accumulated values of the global precision error exceed the preset total tolerance). Accordingly, the global precision error may be obtained based on the weight before the first data type is determined and the weight after the first data type is determined.

According to a fourth step, the data type in which the data type errors are accumulated (e.g., according to an ascending order) may be determined as a second data type of corresponding multiplier columns to replace the first data type.

Therefore, according to an embodiment, a preliminary data type for the multiplier column (of the plurality of multiplier columns) is selected from the plurality of data types. In some cases, the preliminary data type has a lower precision level than the first data type. In case, the preliminary data type does not meet a tolerance condition based on the lower tolerance, a first data type is selected based on the determination that the preliminary data type does not meet the tolerance condition.

Similarly, the data type (e.g., the first data type) for each of the plurality of multiplier columns may be obtained and the data type errors of the said data type may be sorted in an ascending order. In some cases, the sorted data type errors may be accumulated (e.g., in ascending order) to generate a global precision error for the plurality of multiplier columns. In some examples, the data type errors may be accumulated until the global precision error exceeds the preset total tolerance. In some cases, the data type of the said data type errors may be referred to as a second data type for the plurality of multiplier columns.

In some cases, the global precision error may be obtained based on the precision allocation method described in the present disclosure. According to the precision allocation method, in operation 230 (referring to FIG. 2), a current weight element after a change in the first data type may be subtracted from a current weight element of the original high-precision data type (e.g., FP16) to obtain the difference between the current weight elements before and after the change in data types. Subsequently, the difference may be confirmed as an absolute value, and absolute values of interpolated values obtained from each of the weight elements may be added up.

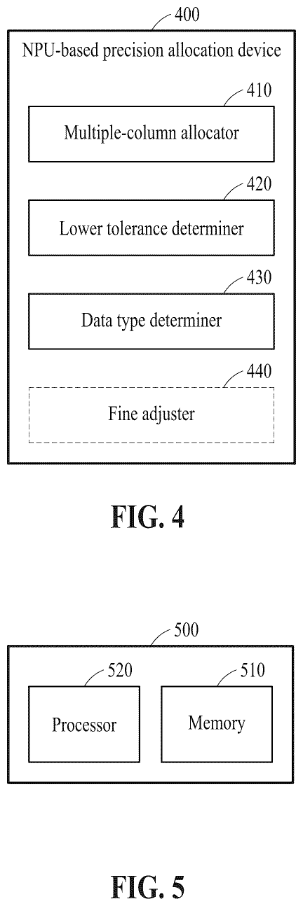

FIG. 4 is a block diagram illustrating a precision allocation device based on an NPU according to an embodiment.

Referring to FIG. 4, a precision allocation device 400 based on an NPU of the present disclosure may include a multiple-column allocator 410, a lower tolerance determiner 420, and a data type determiner 430.

The multiple-column allocator 410 may be configured to allocate a weight of a neural network to multiplier columns. In some cases, each of the multiplier columns may refer to the amount of weight data loaded by the NPU for one operation. In some cases, the size of the multiplier columns may be “N” weight elements of 1×1×M. As used herein, N and M are positive integers and represent the division size of the weight according to an output channel and an input channel, respectively. As used herein, 1×1 represents the height and the width of the weight, respectively.

The lower tolerance determiner 420 may be configured to determine a lower tolerance for each of the multiplier columns based on a preset total tolerance. In some cases, the preset total tolerance may represent the upper limit of an allowable error for precision allocation.

The lower tolerance determiner 420 may determine a proportionality coefficient of each of the multiplier columns based on a weight of each of the multiplier columns. Additionally, the lower tolerance determiner 420 may determine the lower tolerance for each of the multiplier columns based on the preset total tolerance and the proportionality coefficient of each of the multiplier columns.

Additionally, the lower tolerance determiner 420 may determine a variance of each of the multiplier columns based on the weight of each of the multiplier columns. In some cases, the lower tolerance determiner 420 may normalize the variance of each of the multiplier columns with the proportionality coefficient.

The data type determiner 430 may determine a first data type of each of the multiplier columns from a plurality of data types with different accuracies based on the lower tolerance.

The data type determiner 430 may obtain a data type of the lowest degree of precision from the plurality of data types. For example, the data type of the lowest degree of precision refers to a data type in which a data type error for each of the multiplier columns is smaller than the lower tolerance. Additionally, the data type determiner 430 may determine the data type of the lowest degree of precision as the first data type. For example, the data type of the lowest degree of precision refers to a data type in which the data type error is smaller than the lower tolerance. As an example, the plurality of data types may include a DFP_S data type, a DFP_M data type, and a DFP_L data type (as described with reference to FIG. 3).

The precision allocation device 400 based on an NPU of the present disclosure may further include a fine adjuster 440. The fine adjuster 440 may obtain a data type in which a degree of precision is one level lower than the first data type among the plurality of data types for each of the multiplier columns (e.g., where the degree of precision may correspond to a DFP_S when the first data type is DFP_M). Additionally, the fine adjuster 440 may sort data types obtained according to data type errors in ascending order. In some cases, the fine adjuster 440 may sequentially accumulate the data type errors of the data types obtained in ascending order to a global precision error. In some examples, the fine adjuster 440 may repeatedly accumulate the data type errors until the global precision error is greater than or equal to the preset total tolerance. In some cases, the fine adjuster 440 may determine the data types in which the data type errors are accumulated as a second data type of corresponding multiplier columns to replace the first data type. In some cases, the global precision error may be obtained based on a weight before determination of the first data type and a weight after determination of the first data type. Further details regarding operations of the fine adjuster 440 have been described with reference to FIGS. 2-3.

FIG. 5 is a block diagram illustrating an electronic device for performing precision allocation based on an NPU, according to an embodiment.

Referring to FIG. 5, an electronic device 500 of the present disclosure may include a processor 510 and a memory 520 configured to store computer-executable instructions. In some cases, when the instructions are executed by the processor 510, the NPU-based precision allocation method described above with reference to FIG. 2 may be implemented.

The memory 520 may store an operating system, application programs, computer-executable instructions, and storage data to control the overall operation of the electronic device 500.

A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor 510 is configured to operate a memory array using a memory controller. In other cases, a memory controller is integrated into processor 510. In some cases, processor 510 is configured to execute computer-readable instructions stored in memory 520 to perform various functions. In some aspects, processor 510 includes special purpose components for modem processing, baseband processing, digital signal processing, or transmission processing. According to some aspects, processor 510 comprises the one or more processors described herein.

Memory 520 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor 510 to perform various functions described herein.

In some cases, memory 520 includes a basic input/output system (BIOS) that controls basic hardware or software operations, such as an interaction with peripheral components or devices. In some cases, memory 520 includes a memory controller that operates memory cells of memory 520. For example, the memory controller may include a row decoder, column decoder, or both. In some cases, memory cells within memory 520 store information in the form of a logical state. According to some aspects, memory 520 comprises the memory subsystem described with reference to FIG. 21.

As described herein, the processor 510 may allocate a weight of a neural network to multiplier columns of a neural network processor. In some cases, the processor 510 may determine a lower tolerance for each of the multiplier columns based on a preset total tolerance. Additionally, the processor 510 may determine (e.g., select) a first data type of each of the multiplier columns from a plurality of data types with different accuracies based on the lower tolerance. In some cases, each of the plurality of data types corresponds to a different precision level. The processor 510 may further perform a multiplication operation based on the weight and the first data type.

The processor 510 may perform operations of the multiple-column allocator 410, the lower tolerance determiner 420, the data type determiner 430, and the fine adjuster 440 of the precision allocation device 400 of FIG. 4, which is based on artificial intelligence. In some cases, the processor 510 may include configurations of the multiple-column allocator 410, the lower tolerance determiner 420, the data type determiner 430, and the fine adjuster 440 of FIG. 4.

According to an embodiment of the present disclosure, the data type is determined based on the multi-column granularity, and the weight elements within the multiplier columns adopt the same data precision and/or data type, such that the mixed-precision granularity may recognize hardware and may adapt to a computational mode of the NPU. Additionally, the NPU-based precision allocation method of the present disclosure may significantly reduce computational complexity and may improve algorithm efficiency in situations with low precision loss and/or effectiveness loss by selecting the data type based on weight changes and fine-adjusting (e.g., fine-tuning) the data type. Furthermore, since additional training operations are not required, the present disclosure may achieve comprehensive and balanced improvements in terms of mixed-precision granularity, training requirements, and improvements on algorithm efficiency and effectiveness.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or one or more combinations thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

What is claimed is:

1. A method comprising:
allocating a weight of a neural network to a multiplier column of a neural network processor;
determining a lower tolerance for the multiplier column;
selecting a first data type for the multiplier column from a plurality of data types based on the lower tolerance, wherein each of the plurality of data types corresponds to a different precision level; and
performing, by the neural network processor, a multiplication operation based on the weight and the first data type.

2. The method of claim 1, wherein:
the lower tolerance is based on a preset total tolerance representing an upper limit of an allowable error for performing precision allocation.

3. The method of claim 2, wherein the determining of the lower tolerance comprises:
determining a proportionality coefficient for the multiplier column based on a weight of the multiplier column; and
determining the lower tolerance based on the preset total tolerance and the proportionality coefficient.

4. The method of claim 3, wherein the determining of the proportionality coefficient comprises:
determining a variance of the multiplier column; and
normalizing the variance.

5. The method of claim 1, further comprising:
allocating weights of the neural network to a plurality of multiplier columns of the neural network processor, wherein a size of each of the plurality of multiplier columns is 1×1×M, where M is a positive integer.

6. The method of claim 1, wherein selecting of the first data type comprises:
determining that the first data type results in a data type error that is lower than the lower tolerance.

7. The method of claim 1, wherein the selecting of the first data type comprises:
selecting a preliminary data type for the multiplier column from the plurality of data types, wherein the preliminary data type has a lower precision level than the first data type;
determining that the preliminary data type does not meet a tolerance condition based on the lower tolerance; and
selecting the first data type based on the determination that the preliminary data type does not meet the tolerance condition.

8. The precision allocation method of claim 1, wherein:
the plurality of data types comprises:
a dynamic floating point small (DFP_S) data type;
a dynamic floating point medium (DFP_M) data type; and
a dynamic floating point large (DFP_L) data type.

9. A non-transitory computer-readable storage medium storing instructions that, when executed by a processor, cause the processor to perform the method of claim 1.

10. A computing device comprising:
a multiple-column allocator configured to allocate a weight of a neural network to a multiplier column of a neural network processor;
a lower tolerance determiner configured to determine a lower tolerance for the multiplier column; and
a data type determiner configured to select a first data type for the multiplier column from a plurality of data types based on the lower tolerance, wherein each of the plurality of data types corresponds to a different precision level.

11. The computing device of claim 10, wherein
the lower tolerance is based on a preset total tolerance representing an upper limit of an allowable error for performing precision allocation.

12. The computing device of claim 11, wherein the lower tolerance determiner is configured to:
determine a proportionality coefficient for the multiplier column based on a weight of the multiplier column; and
determine the lower tolerance based on the preset total tolerance and the proportionality coefficient.

13. The computing device of claim 12, wherein the lower tolerance determiner is configured to:
determine a variance of the multiplier column; and
normalize the variance.

14. The computing device of claim 10, wherein the multiple-column allocator is further configured to allocate weights of the neural network to a plurality of multiplier columns of the neural network processor,
wherein a size of each of the plurality of multiplier columns is 1×1×M, where M is a positive integer.

15. The computing device of claim 10, wherein
the data type determiner is configured to select the first data type further comprising:
determine that the first data type results in a data type error that is lower than the lower tolerance.

16. The computing device of claim 10, further comprising:
a fine adjuster configured to:
select a preliminary data type for the multiplier column from the plurality of data types, wherein the preliminary data type has a lower precision level than the first data type;
determine that the preliminary data type does not meet a tolerance condition based on the lower tolerance; and
select the first data type based on the determination that the preliminary data type does not meet the tolerance condition.

17. The computing device of claim 10, wherein:
the plurality of data types comprises:
a dynamic floating point small (DFP_S) data type;
a dynamic floating point medium (DFP_M) data type; and
a dynamic floating point large (DFP_L) data type.

18. An electronic device comprising:
a memory; and
a processor,
wherein the processor is configured to:
allocate a weight of a neural network to a multiplier column of a neural network processor;
determine a lower tolerance for the multiplier column;
select a first data type for the multiplier column from a plurality of data types based on the lower tolerance, wherein each of the plurality of data types corresponds to a different precision level; and
perform a multiplication operation based on the weight and the first data type.
